(19) United States
(12) Patent Application Publication
(10) Pub. No.: US 2010/0198978 A1
(43) Pub. Date: Aug. 5, 2010

(54) COMMUNICATION DATA PROCESSING APPARATUS, INTEGRATED CIRCUIT APPARATUS, AND METHOD

(75) Inventors: Yuki Kobayashi, Osaka (JP); Kentaro Saito, Osaka (JP); Taku Matsuda, Nara (JP); Kenji Shioyama, Kyoto (JP)

Correspondence Address: WENDEROTH, LIND & PONACK L.L.P., 1030 15th Street, N.W., Suite 400 East, Washington, DC, 20005-1503, US

(73) Assignee: MATSUSHITA ELECTRIC INDUSTRIAL CO., LTD., Osaka (JP)

(21) Appl. No.: 11/911,066

(22) PCT Filed: Jul. 11, 2006
(86) PCT No.: PCT/JP2006/313747

§ 371 Date: Oct. 9, 2007

(30) Foreign Application Priority Data
Jul. 14, 2005 (JP) 2005-206123

(51) Int. Cl. G06F 15/16

(52) U.S. Cl. 709/231; 709/236

(57) ABSTRACT

A communication data processing apparatus which distributes streaming data and other general data other than the streaming data obtained via a network to a decoder and a CPU respectively, and which is configured to be independent from the CPU, includes: a communication data obtaining unit (31) which obtains communication data from a PHY (20) that transmits and receives a physical signal to and from the network; a frame sorting unit (33) which partitions the obtained communication data into frames and sorts specific frames which include streaming data, out of the respective partitioned frames; a streaming data output unit (35) which outputs the streaming data that is included in the sorted specific frames to a decoder (40); and a general frame output unit (36) which outputs general frames other than the sorted specific frames to a MAC (51) that performs data link processing.

### TECHNICAL FIELD

The present invention relates to a communication data processing apparatus, and particularly to a technique for sorting communication data including streaming data obtained via a network, into streaming data and general data other than the streaming data.

### BACKGROUND ART

Recently, broadcasting via a computer network has become popular. Distribution of contents via a network in broadcasting is typically carried out with a streaming system via the Internet.

A personal computer and a handheld information terminal, as reproduction apparatuses obtain streaming data which expresses a content along with general data such as electronic mail data and web data from the Internet. Then, along with decoding the streaming data and reproducing the content, the processing of the general data, such as electronic mail and web browsing, is also performed.

There are cases where the personal computer and the handheld information terminal, as a reproducing apparatus, include a decoder specifically dedicated to streaming data, aside from a general-purpose Central Processing Unit (CPU) which processes general data. An image reception apparatus, adapted to such a configuration, which forwards streaming data obtained from a network to the dedicated decoder, and forwards general data to the general-purpose CPU, is well known (see patent reference 1, for example).

FIG. 1 is a function block diagram showing the essential units of a video reception apparatus 90 shown in patent reference 1. The video reception apparatus 90 is an apparatus which sorts general data and streaming data obtained from a network 70 using a packet selector unit 83, and processes the sorted general data and streaming data on a general-purpose CPU 91 and a dedicated decoder 94 respectively.

By transmitting and receiving a physical signal to and from the network 70 using a physical layer processing unit (PHY) 81 and carrying out data link processing using a media access control unit (MAC) 82, communication data which includes streaming data is obtained from the network 70.

A packet selector unit 83, through a hardware circuit, autonomously sorts the general data and the streaming data out of communication data of which data link processing has been carried out, and a bus controller 85 outputs the general data to the CPU 91 via a CPU bus 93, and an interface unit (I/F) 84 outputs the streaming data to the dedicated decoder 94. A memory 92 is used in the processing of general data by the CPU 91.

By adopting the above configuration, the need for a dedicated processor or for sorting data at the expense of the CPU 91 is eliminated, and since the path for streaming data which usually has a large amount of data is to be separated, the bandwidth required by the CPU bus 93 may be reduced.
Patent Reference 1: Japanese Unexamined Patent Application Publication No. 2004-336437.

### DISCLOSURE OF INVENTION

### Problems that Invention is to Solve

However, according to the above-mentioned conventional image reception apparatus, the general data is outputted to the CPU 91 via the CPU bus 93. Therefore, in order to adapt to different types of buses, such as a PCI (Peripheral Component Interconnect) bus, an SRAM (Static Random Access Memory) bus, and several buses that are dedicated to a predetermined CPU, for example, it is necessary to create a different variety including a different bus controller 85, and this becomes an inhibiting factor to the rationalization of designing, production, and use of the apparatus.

The present invention is conceived to solve the above-mentioned problems and has as an object to provide a communication data processing apparatus which sorts general data and streaming data that is obtained via a network, and which is a rational communication data processing apparatus that is not dependent on the bus type.

### Means to Solve the Problems

In order to solve the above problems, the integrated circuit of the present invention is an integrated circuit, for communication data processing, which processes communication data obtained via a network and which includes streaming data, the integrated circuit includes: a communication data obtaining circuit which obtains the communication data from a physical layer processing unit which transmits and receives a physical signal to and from the network; a frame partitioning circuit which partitions, into frames, the communication data obtained by said communication data obtaining circuit; a frame sorting circuit which sorts a streaming frame out of the respective partitioned frames, the streaming frame being a frame which includes streaming data; a streaming data output circuit which outputs, to a decoder, the streaming data included in the sorted streaming frames; and a general frame output circuit which outputs a general frame to a media access control unit which performs data link processing, the general frame being a frame other than the sorted streaming frame.

Moreover, in order to solve the above problems, the communication data processing apparatus of the present invention is a communication data processing apparatus which processes communication data obtained via a network and which includes streaming data, said communication data processing apparatus includes: a communication data obtaining unit which obtains the communication data from a physical layer processing unit that transmits and receives a physical signal to and from the network; a frame partitioning unit which partitions, into frames, the communication data obtained by the communication data obtaining unit; a frame sorting unit which sorts a streaming frame out of the respective partitioned frames, the streaming frame being a frame which includes streaming data; a streaming data output unit operable to output, to a decoder, the streaming data included in the sorted streaming frame; and a general frame output unit which outputs a general frame to a media access control unit that performs data link processing, the general frame being a frame other than the sorted streaming frame.

Furthermore, it is preferable that the general frame output unit outputs the general frame to the media access control unit in conformance to at least one of a media independent interface and a gigabit media independent interface which are defined by the ISO/IEC 8802-3 standard.

According to this configuration, the communication data processing apparatus and the integrated circuit apparatus that is the implementation thereof are provided between the physical layer processing unit and the aforementioned media access control unit, sort the data before the media access control unit, and output the general data not to a CPU bus but to the media access control unit. As a result, according to an interface provided between the physical layer processing unit and the media access control unit, and which has been conventionally standardized so as not to depend on the CPU bus, the aforementioned general frame can be outputted to the aforementioned media access control unit.

It is preferable to use the media independent interface and the gigabit media independent interface in order to apply the communication data processing apparatus to the IP (Internet Protocol) network which has been widely used as the de facto standard at the present moment.

Furthermore, it is also possible that the communication data includes a plural of preambles each having a predetermined value and indicating a boundary between frames, and the frame partitioning unit partitions the communication data into the frames by detecting the preambles from the communication data.

Furthermore, it is also possible that the communication data processing apparatus is provided with a reference IP address and a reference port number, and the frame sorting unit sorts the specific frame from among frames having a frame type of IPv4 or IPv6 out of the respective partitioned frames, based on a comparison between a destination IP address of an IP header included in the frame and the reference IP address, and a comparison between a destination port number of the IP header and the reference port number.

According to this configuration, the aforementioned communication data processing apparatus is suitable for application to the IP network.

Furthermore, it is also possible that the communication data processing apparatus includes the physical layer processing unit.

According to this configuration, it is possible to obtain a highly convenient communication data processing apparatus, which includes a function for transmission and reception of a physical signal toward a network, in addition to a sorting function of a frame.

Furthermore, the present invention can be implemented not only as the communication data processing apparatus and the integrated circuit apparatus as mentioned above, but also as a communication data processing method having the processes executed by the characteristic units included in the communication data processing apparatus, as a steps.

### Effects of the Invention

The communication data processing apparatus of the present invention outputs sorted general data to the aforementioned media access control unit according to an interface, provided between a physical layer processing unit and a media access control unit, which has conventionally been standardized in order not to depend on a CPU bus, so that a rational communication data processing apparatus which is independent from a bus type can be obtained.

### BRIEF DESCRIPTION OF DRAWINGS

FIG. 1 is a function block diagram which shows a configuration example of a conventional image reception apparatus.

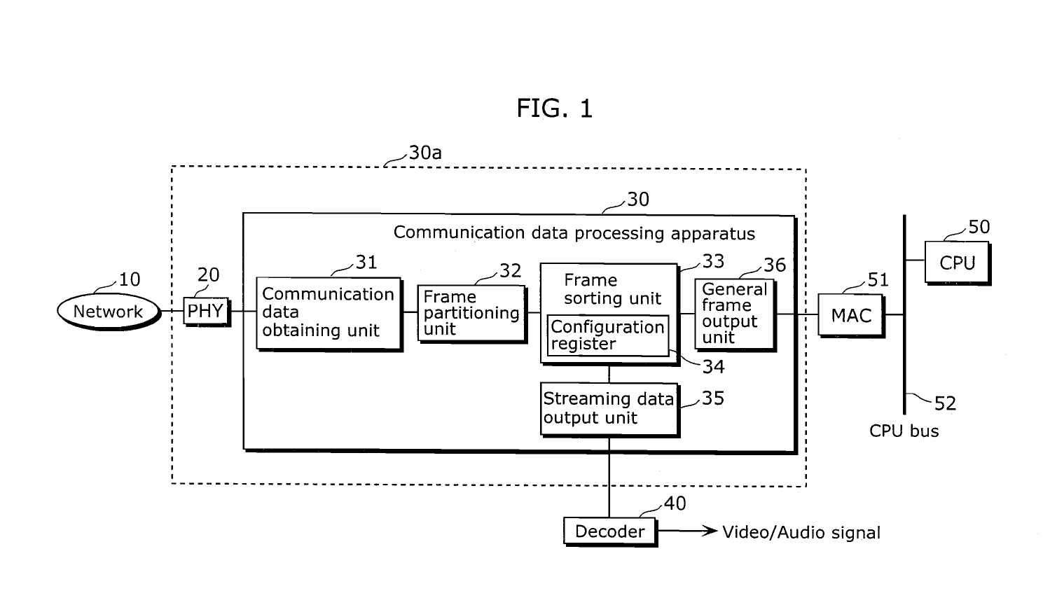

FIG. 2 is a function block diagram which shows a configuration example of a communication data processing apparatus according to an embodiment of the present invention.

FIG. 3 shows a content example of a configuration register.

FIG. 4 is a flowchart which shows an operation example of the communication data processing apparatus.

### NUMERICAL REFERENCES

10 Network

20 PHY

30,30a Communication data processing apparatus

31 Communication data obtaining unit

32 Frame partitioning unit

33 Frame sorting unit

34 Configuration register

35 Streaming data output unit

36 General frame output unit

40 Decoder

50 CPU

51 MAC

52 CPU bus

70 Network

81 Physical layer processing unit

82 Media access control unit

83 Packet selector unit

84 Interface unit

85 Bus controller

90 Image reception apparatus

91 CPU

92 Memory

93 CPU

94 Decode

### BEST MODE FOR CARRYING OUT THE INVENTION

The embodiment of the present invention is described referring to the drawings as follows.

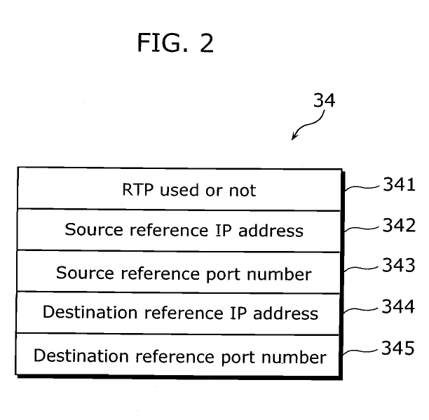

FIG. 2 is a function block chart showing a configuration example of a communication data processing apparatus 30 according to the embodiment of the present invention.

The communication data processing apparatus 30 is an apparatus which is provided between a physical layer processing unit (PHY) 20 and a media access control unit (MAC) 51, and which outputs streaming data obtained from a network 10 via the PHY 20 to a decoder 40 and outputs general data to the MAC 51. The communication data processing apparatus 30 includes a communication data obtaining unit 31, a frame partitioning unit 32, a frame sorting unit 33, a streaming data output unit 35, and a general frame output unit 36. The frame sorting unit 33 includes a configuration register 34 which holds information that regulates operations. Details of the configuration register 34 are described later.

The communication data processing apparatus 30 may also be implemented as a semiconductor integrated circuit apparatus, for example. In that case, the communication data obtaining unit 31, the frame partitioning unit 32, the frame sorting unit 33, a configuration register 34, the streaming data output unit 35, and the general frame output unit 36 are implemented as circuit blocks which performs their respective functions.

Note that a communication data processing unit 30a which is configured to include the PHY 20 is also included in the present invention. Moreover, a communication data processing apparatus which is configured to include the MAC 51 may also be considered as the present invention.

The PHY20 transmits and receives a physical signal to and from the network 10, and obtains communication data which includes streaming data. The transmission and receiving of the physical signal can be performed using conventional techniques as appropriate. For example, in the case where the network 10 is an Ethernet(™) 10 BASE-T, Manchester Decoding is performed on the physical signal so as to convert it to usual digital data.

The communication data obtaining unit 31 obtains the communication data from the PHY 20. It is preferable that the obtaining of the communication data is performed in accordance with the media independent interface (MII) or the gigabit media independent interface (GMII) which conforms to the ISO/IEC 8802-3 standard. Accordingly, a conventional physical layer processing unit which transmits the communication data to a media access controlling unit in accordance with the MII and the GMII may be used, as is, as the PHY 20.

The communication data obtaining unit 31 is implemented through an input circuit and an input terminal which conform to the MII and GMII, for example. However, in the case where the communication data processing apparatus 30 and the PHY 20 are implemented on the same semiconductor integrated circuit, the communication data obtaining unit 31 may be implemented as an internal signal transmission circuit of the semiconductor integrated circuit.

The frame partitioning unit 32 partitions the communication data obtained from the communication data obtaining unit 31 into frames which are units of communication, by performing a part of the processing which is carried out by a conventional media access control unit.

The frame sorting unit 33 sorts frames including the streaming data out of the respective partitioned frames, and distributes the sorted frames (referred to as streaming frames in the present specification) and the other frames (referred to as general frames in the present specification) to the streaming data output unit 35 and the general frame output unit 36, respectively.

The streaming data output unit 35 outputs the streaming data included in the streaming frames to the decoder 40. The streaming data output unit 35 is implemented through a general output circuit and a general output terminal, for example.

The decoder 40 decodes the streaming data transmitted by the streaming data output unit 35, and outputs an video/audio signal.

On the other hand, the general frame output unit 36 outputs the general frames to the MAC 51 that performs data link processing. It is preferable that the outputting of the general frames is performed in accordance with the MII or the GMII. Accordingly, a conventional media access processing unit which receives the communication data from a physical layer processing unit in accordance with the MII or the GMII may be used, without modification, as the MAC 51.

The general frame output unit 36 is implemented through an output circuit and an output terminal that conform to the MII or the GMII, for example.

The MAC 51 performs the same conventional data link processing for the general frames, and outputs the general frames for its own apparatus to a CPU 50 via a CPU bus 52. The CPU 50 processes the data contained in the general frames that are obtained from the MAC 51. This processing is, for example, browsing electronic mail or web pages depending on the content of the data. The MAC 51 may also be included in the CPU 50 and, as mentioned above, may be included as part of the communication data processing apparatus of the present invention.

Note that in the above description, the MII and the GMII are mentioned as examples of an interface between the PHY 20 and the communication data processing apparatus 30 and an interface between the communication data processing apparatus 30 and the MAC 51. However, other standardized interfaces may also be used as a matter of course. For example, use of the RMII, the RGMII, and the SMII with fewer terminals and the XGMII that complies with the 10-gigabit Ethernet(™) may be considered as well.

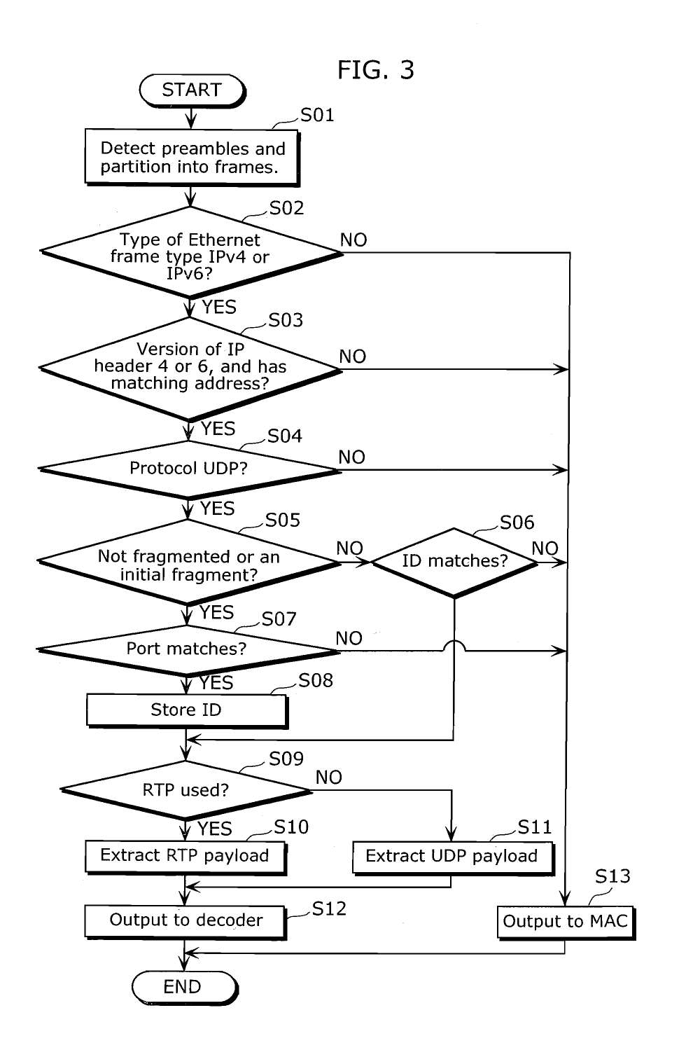

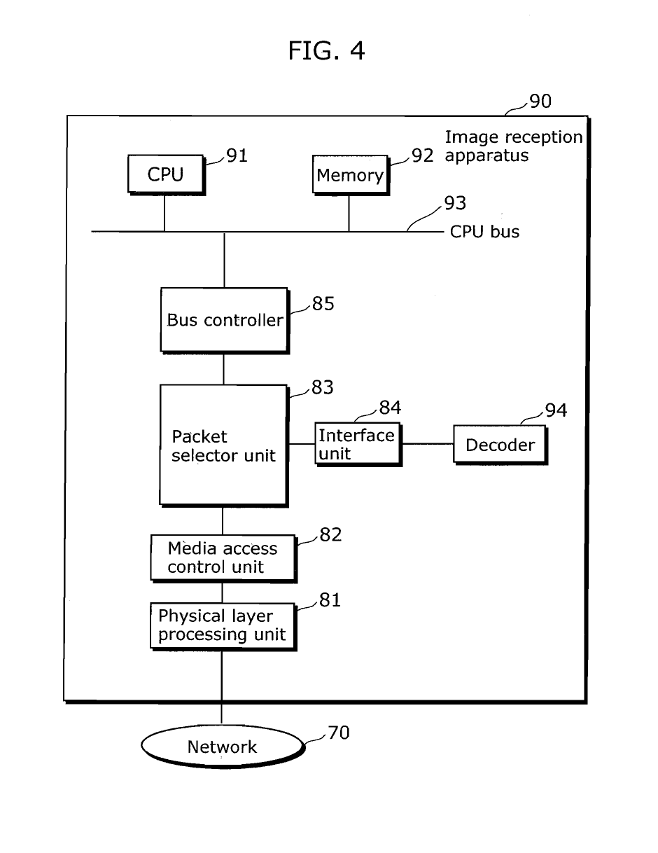

Next, an example of the operation of the communication data processing apparatus 30 shall be described with reference to FIG. 3 and FIG. 4.

Specifically, this operation example describes that the network 10 is Ethernet(™), and the streaming data is transmitted through the UDP (User Datagram Protocol) or the RTP (Real-time Transport Protocol). Note that since the format of Ethernet(™) frames, IP packets, LIDP packets, and RTP packets are very well known, description herein shall be omitted.

FIG. 3 shows an example of information that is stored in the configuration register 34, and which regulates the operation of the communication data processing apparatus 30. The configuration register 34 holds: an RTP used or not 341 which indicates whether the streaming data is transmitted through the LIDP or the RTP; a source reference IP address 342 and a source reference port number 343 which identify the source of the streaming data; and a destination reference IP address 344 and a destination reference port number 345 which identify the communication data processing apparatus 30 of the present invention.

The above information is set by the CPU 50 when the communication data processing apparatus 30 is activated, for example. Then, communication data processing apparatus 30 performs the sorting of data by referring to the information from the configuration register 34.

The present invention is not limited to a specific configuration for obtaining the information. However, as an example, the communication data processing apparatus 30 can obtain the information via the MII and the GMII as well. For that purpose, the CPU 50 may provide an identification signal (not illustrated) which indicates whether the data via the MII and the GMII is the information or the communication data, to the communication data processing apparatus 30, and the communication data processing apparatus 30 may store the data obtained via the MII and the GMII in the configuration register 34 or process the data as regular transmission data, in accordance with the identification signal.

FIG. 4 is a flowchart which shows an example of a sorting operation of data that is performed by the communication data processing apparatus 30.

By detecting preambles from the communication data obtained from the communication data obtaining unit 31, the frame partitioning unit 32 partitions the communication data into Ethernet(™) frames (referred to as frames hereinafter) (S01). Steps after S02 are executed on the respective partitioned frames.

The frame sorting unit 33 sorts out a frame in the case where: the type of the frame is IPv4 or IPv6 (S02); the version of the IP header is 4 or 6, the source IP address of the IP header matches to the source reference IP address that is stored in the configuration register 34, and the destination IP address of the IP header matches to the destination reference IP address that is stored in the configuration register 34 (S03); the protocol is the UDP (S04); the frame is not fragmented or is an initial fragment (YES in S05), the source port number of the UDP header matches the reference source port number that is stored in the configuration register 34, and the address port number of the UDP header matches the address reference port number that is stored in the configuration register 34 (S07). Then, the frame sorting unit 33 stores the ID of the frame in a register which is not illustrated (S08).

The frame sorting unit 33 also sorts out a frame in the case where the frame is a non-initial fragment (NO in S05) and the ID of the frame matches the ID that is stored (S06).

When the RTP used or not that is stored in the configuration register 34 indicates used (YES in S09), the frame sorting unit 33 extracts the RTP payload from the sorted frame (S10), and when the RTP used or not does not indicate used presence (NO in S09), the frame sorting unit extracts the UDP payload from the sorted frame (S11). The streaming data output unit 35 outputs the respective extracted payloads to the decoder 40 (S12).

In the case where the frame sorting unit 33 provides a negative judgment at any of the series of judgments for sorting a frame (S02, S03, S04, S06, and S07), the general frame output unit 36 outputs such frame to the MAC 51.

Note that these judgments may be skipped individually. For example, there are cases where the source port may not be checked in actual use.

As described above, since the communication data processing apparatus 30 of the present invention is located between the PHY 20 and the MAC 51, and performs sorting of data before the MAC 51, and outputs the sorted general data to the MAC 51 according to an interface, such as the MII and the GMII, that is independent from the CPU bus a rational communication data processing apparatus which is independent of the bus type can be obtained.

### INDUSTRIAL APPLICABILITY

The present invention can be applied to network adapters, and can be especially applied for use in decoders and reception apparatuses for network broadcasts.

1. An integrated circuit, for communication data processing, which processes communication data obtained via a network and which includes streaming data, said integrated circuit apparatus comprising:
a communication data obtaining circuit which obtains the communication data from a physical layer processing unit which transmits and receives a physical signal to and from the network;
a frame partitioning circuit which partitions, into frames, the communication data obtained by said communication data obtaining circuit;
a frame sorting circuit which sorts a streaming frame out of the respective partitioned frames, the streaming frame being a frame which includes streaming data;
a streaming data output circuit which outputs, to a decoder, the streaming data included in the sorted streaming frames; and
a general frame output circuit which outputs a general frame to a media access control unit which performs data link processing, the general frame being a frame other than the sorted streaming frame.

2. A communication data processing apparatus which processes communication data obtained via a network and which includes streaming data, said communication data processing apparatus comprising:
a communication data obtaining unit operable to obtain the communication data from a physical layer processing unit which transmits and receives a physical signal to and from the network;
a frame partitioning unit operable to partition, into frames, the communication data obtained by said communication data obtaining unit;
a frame sorting unit operable to sort a streaming frame out of the respective partitioned frames, the streaming frame being a frame which includes streaming data;
a streaming data output unit operable to output, to a decoder, the streaming data included in the sorted streaming frame; and
a general frame output unit operable to output a general frame to a media access control unit which performs data link processing, the general frame being a frame other than the sorted streaming frame.

3. The communication data processing apparatus according to claim 2,
wherein said general frame output unit is operable to output the general frame to the media access control unit in conformance to at least one of a media independent interface and a gigabit media independent interface which are defined by the ISO/IEC 8802-3 standard.

4. The communication data processing apparatus according to claim 2,
wherein the communication data includes a plural of preambles each having a predetermined value and indicating a boundary between frames, and
said frame partitioning unit is operable to partition the communication data into the frames by detecting the preambles from the communication data.

5. The communication data processing apparatus according to claim 2,
wherein said communication data processing apparatus is provided with a reference IP address and a reference port number, and
said frame sorting unit is operable to sort the streaming frame from among frames having a frame type of IPv4 or IPv6 out of the respective partitioned frames, based on a comparison between a destination IP address of an IP header included in the frame and the comparison IP address, and a comparison between a destination port number of a UDP header included in the frame and the reference port number.

6. The communication data processing apparatus according to claim 2 comprising
the physical layer processing unit.

7. A communication data processing method which is for processing communication data obtained via a network and which includes streaming data, said communication data processing method comprising:
a communication data obtaining step of obtaining the communication data from a physical layer processing unit which transmits and receives a physical signal to and from the network;
a frame partitioning step of partitioning, into frames, the communication data obtained in said communication data obtaining step;
a frame sorting step of sorting a streaming frame out of the respective partitioned frames, the streaming frame being a frame which includes streaming data;
a streaming data outputting step of outputting, to the decoder, the streaming data included in the sorted streaming frame; and
a general frame output step of outputting a general frame to a media access control unit which performs data link processing, the general frame being a frame other than the sorted streaming frame.
